(19) United States
(12) Patent Application Publication
(10) Pub. No.: US 2005/0129246 A1
(43) Pub. Date: Jun. 16, 2005

(54) Intelligent digital secure LockBox and access key distribution system (DLB)

(76) Inventor: Glenn Gearhart, Huntington Beach, CA (US)

Correspondence Address: Joseph C. Andras;MYERS DAWES ANDRAS & SHERMAN LLP, Suite 1150, 19900 MacArthur Blvd., Irvine, CA, 92612, US

(21) Appl. No.: 10/737,372

(22) Filed: Dec. 16, 2003

(51) Int. Cl. H04L 9/00

(52) U.S. Cl. 380/278

(57) ABSTRACT

An intelligent secure digital access code storage lock box and an access code or key distribution system. The method and system includes an intelligent digital lock box having embedded processing functionality and a user interface capable of receiving electronic queries, the reception, storage, access to, and deletion of digital access codes or keys such as encryption keys, access codes, passwords, pin numbers, account numbers and other valuable codes, and an informational note pad capable of accepting, editing and the deletion textual and other forms of digital information and the capability to delivery the encryption secure lock box and its contents to remote parties, all in encrypted format. It also provides every individual with the capability to carry all of his access codes, access key passwords and other controls with him wherever he travels and allows direct and immediate access to e-mail accounts, password or key protected web pages, on-line bank accounts and other on-line access controlled areas from any computer any where in the world.

### DESCRIPTION OF THE INVENTION

### FIELD OF THE INVENTION

The present invention relates generally to both wireline and wireless networks and to a system or method for providing any computer users with the ability to upon-demand create a secure LockBox and to be able to transfer a secure LockBox to one or more computers and their recipient users where the LockBox contains one or more digital access codes or keys.

A more particular aspect of the present invention is related to enabling any unsophisticated computer user, with access to a computer or digital device to establish, maintain, operate and dismantle a Intelligent Digital Secure LockBox and Access Key Distribution System (DLB).

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described and in the drawings hereto: Copyright 2002-2003, ACAP Security, Inc., All Rights Reserved.

### BACKGROUND OF THE INVENTION

This invention focuses on addressing at least two major issues associated with 1) the local security, storage and management of encryption keys, passwords, access codes, pin numbers and other digital access codes and keys and 2) the transfer of or distribution of these confidential and secret items to third parties.

### LOCAL SECURITY OF ACCESS CODES AND KEYS

It is continually preached to every user with access rights to a protected area or to a secure area or set of data—“The system security is only as good as the security of the access codes or keys!” and “Passwords written on post-its and tacked to the side of a computer monitor are even more un-secure than leaving your house key under the doormat at the front door.”

But such breaches of, or negligence about, security are common and in some cases even prevalent. With the increase in cyber-crime attacks and the inevitable cyber-terror attack upon the American segment of cyberspace, the Federal government under the Federal Security Information Management Act (FISMA) is pursuing an upgrade, not only in security awareness, but also in the actual enforcement, of security policies and procedures. Similar emphasis is being directed at private industry under the various Federal Act, such as the “Health Insurance Portability and Accountability Act (HIPAA) addressing medical information privacy, and the Gramm-Leach-Bliley Act (GLB Act) governing financial privacy. Many state legislatures are also enacting legislation that establish stronger digital information privacy rights.

Because password protection is one of the weakest links in the security chain, and because of the increase in the use of encryption wrapping to secure sensitive, confidential and secret digital data and the resulting creation of encryption keys, it has become increasingly important that a simple to use, secure, digital device be available to provide computer users with a secure apparatus to hold these many encryption key, codes, passwords, PIN numbers, etc. which are provided to a computer user, or a bank teller device user, or a on-line financial transaction service user, with the instruction to “keep it secure.”

Further, with the advent of 128-bit, 192-bit, 256-bit and larger encryption keys and increased bit lengths in passwords, and the for security reasons the desire that and such keys or passwords include one or two “special” characters, include both upper and lower case characters, plus other rules, it is nearly impossible for a user to memorize and recall the many access keys encryption keys and passwords which he or she collects. Add to that crisis the fact that keys and passwords may be changed weekly or monthly and the propensity for users to write them down and thereby expose the keys and passwords to comprise are very high.

### DISTRIBUTION SECURITY OF ACCESS CODES AND KEYS

The prior discussion of security weaknesses only addressed the management of keys, codes and passwords by a local user. The security risk is compounded by the need for the keys, codes and passwords to be transferred, or delivered, to a third party such that the third party can open and gain access to an encrypted data file—He needs the key, code or password to open any transferred encryption locked data file.

There are currently many unique systems for transferring data and information between two points in what is defined as a secure communications link. Some of these create a secure tunnel or pipeline between the source and the destination others secure the data with an encryption wrap and sent the wrapped data over unsecured private and public data link to the destination.

When the latter approach is utilized the delivered encrypted data files are of no benefit to the recipient if he can not open the data files, that is, decrypt them or unwrap the encryption placed upon the data file.

To accomplish this task the recipient must posses the correct encryption key access code or password. One of the purposes of this invention is to address and solve the common security weaknesses that prevail in the delivery of one or more of these encryption keys, access codes or passwords associated with the transfer of individually encrypted data files.

In reviewing the prior art one finds that this subject has not been a prevalent area of interest for the filing of patent applications. The following prior art provides a few approaches to the weakness discussed but are not as simple as DLB for the user to use, and are not truly a “personal” lock box which an individual can remove and carry with him and easily utilize at any computer or digital device to which he has access. The prior art includes: U.S. Pat. No 6,625,734, Marvit, Sep. 23, 2003, 713/201, tilted: Controlling and tracking access to disseminated information; U.S. Pat. No 6,624,742, Romano, Sep. 23, 2003, 340/5.73, tilted: Wireless real estate electronic lock box; U.S. Pat. No. 6,601,169, Andrews, Nov. 27, 2001, 713/157, tilted: Risk management for public key management; U.S. Pat. No. 6,356,941, Cohen, Mar. 12, 2002, 709/219, titled: Network vaults.

In view of the aforementioned shortcomings associated with the secure management of encryption keys, access codes, passwords and other digital access codes in the existing prior art, there exists a strong need in the art for both a local secure LockBox and a delivery type of LockBox capability which permits secure communications and data transfer without substantial risk of compromise of the transmitted information. Furthermore, their exists the need for such a data transfer security system to allow flexibility in the mobility of the network user participants and also flexibility in the computer devices and operating software and hardware platforms utilized by the participants.

As discussed in the claims and in the detailed description the present invention effectively addresses each of these security and the associated mobility and flexibility issues.

### SUMMARY OF THE INVENTION

To address the above weaknesses in the prior art and other limitations of the prior art, systems and methods are provided that easily and effectively leverage the power of a shared public network, such as the Internet, with one or multiple Intranets in the establishment of secure access codes and access keys delivery system without the complexity, cost, or time associated with setting up traditional LAN, WAN or VPN. Rather than requiring specialized IT staffing and resources, the present invention, DLB, with the defined methods and systems, is capable of allowing an unsophisticated user with access to a standard personal computer (PC), a laptop computer, personal digital assistant (PDA) and other wireless and wireline digital information devices to quickly establish and utilized the access code protection features offered by DLB. It also allows the unsophisticated user with the capability to attach a LockBox to an e-mail message, or other means of transfer, and deliver one or more encryption keys, access codes, passwords and other sensitive, confidential or secret access control information.

Accordingly, it is an objective of the present invention to provide every user of a computer or digital information device the ability to create one or more of his or her LockBoxes and DLBs upon demand and allow the secure digital LockBox to be directed to any specific recipient, point or party, or any multiple number of recipients, points and parties, as the LockBox creator may desire, anywhere in the world.

Another objective of the present invention to provide a highly secure protection scheme for the transfer of encryption key, access codes and password data over any public or private network, and over any wireline and wireless network, and to allow the sharing of sensitive, confidential and secret digital key, code and password information through the communication features of the DLB.

Another objective of the present invention is to provide a security protection system which places minimal operational burdens upon the LockBox creator and all of the participating members of the LockBox distribution network.

Another objective of the present invention is to provide a LockBox and DLB secure access key to be resident and maintained within a removable hardware-software media or device, such as a flash USB drive, a writable DVD, or CD or diskette, each which includes all of the programming code, data and logic required to allow any party who desires to use any computer or digital information device to create a LockBox or DLB, or who desires to use any computer or digital information device to deliver a LockBox or DLB and to gain such access and rights by simply inserting the removable storage device into a USB port, or the DVD or CD or diskette drive on the computer or digital information device, and initiating the DLB process.

And, another objective of the present invention is to provide full flexibility and mobility as to the physical locations and digital information devices which are utilized by the user in creating a LockBox and delivering one or more LockBoxes to recipient clients.

These and other objectives and advantages of the present invention will become clear to those skilled in the art in view of the description of the best presently known mode of carrying out the invention and the industrial applicability of the preferred embodiment as described herein and as illustrated in the several figures of the drawings.

To the accomplishment of the foregoing and related ends, the invention, then, comprises the features hereinafter fully described and particularly pointed out in the claims. The following description and the included drawings set forth in detail are illustrative embodiments of the invention. These embodiments are indicative, however, of but a very few of the various ways in which the principles of the invention may be employed. Other objectives, advantages and novel features of the invention will become apparent from the following detailed description of the invention when considered in conjunction with the drawings and claims.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and sub-combinations of the disclosed features and/or combinations and sub-combinations of several further features disclosed below in the detailed description.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1.—illustrates a diagram of the functional relationships of a DLB in accordance with methods and systems consistent with the present invention. It shows the relationships of the two required components: the Recipient Clients (RCs); and the Source Clients (SC) and the optional component the Removable Storage Device (RSD);

FIG. 2.—illustrates an example of the sample steps associated with the local establishment and maintenance of a LockBox (LB) by a source client;

FIG. 3.—illustrates an example of the sample steps associated with the establishment and preparation of a LockBox for delivery to a recipient client;

FIG. 4.—illustrates an example of the sample steps associated with the reception of a LockBox and the access control keys; and

FIG. 5.—illustrates an example of the sample steps associated with the use of the LockBox.

### DETAILED DESCRIPTION OF THE PREFERRED EMBODIMENT OF THE INVENTION

Reference will now be made in detail to the construction and operation of an implementation of the present invention which is illustrated in the accompanying drawings. The present invention is not limited to this presented implementation but it may be realized by many other implementations.

The teachings of the present invention are applicable to many different types of computer networks and communication systems. As will be appreciated by those of ordinary skill in the art, while the following discussion sets forth various sample or even preferred implementations of the method and system of the present invention, these implementations are not intended to be restrictive of the provided claims, nor are they intended to imply that the claimed invention has limited applicability to one type of computer or communications network. In this regard, the teachings of the present invention are equally applicable for use in local area networks of all types, wide area networks, private networks, on-line subscription services, on-line database services, private networks, and public networks including the Internet and the World Wide Web and any other means of digital transfer of information. While the principles underlying the Internet and the World Wide Web are described in some applications detailed herein below in connection with various aspects of the present invention, this discussion is provided for descriptive purposes only and is not intended to imply any limiting aspects to the broadly claimed methods and systems of the present invention.

Accordingly, as will be appreciated by those of ordinary skill in the art, as used herein, the term “client” refers to an individual who has authorized access to a digital information device, which maybe a client computer (or machine), in many functional and physical forms including but not limited to desk-tops, workstations, lap tops and PDAs, which are or can be attached to a network, or to a process, such as a Web browser, which runs on a client digital information device in order to facilitate network connectivity and communications. Thus, for example, a “digital information device” can store one or more “client processes.” The term removable storage device (RSD), refers to any hardware-software device which can digitally store and provide access to digital code, data and logic which as part of the present invention facilitates a party to become a participant of a DLB. Typically this would be represented with a flash USB drive but it could also be represented by a DVD, a CD, a computer diskette or some other form of portable and removable digital media device.

Description of Operations

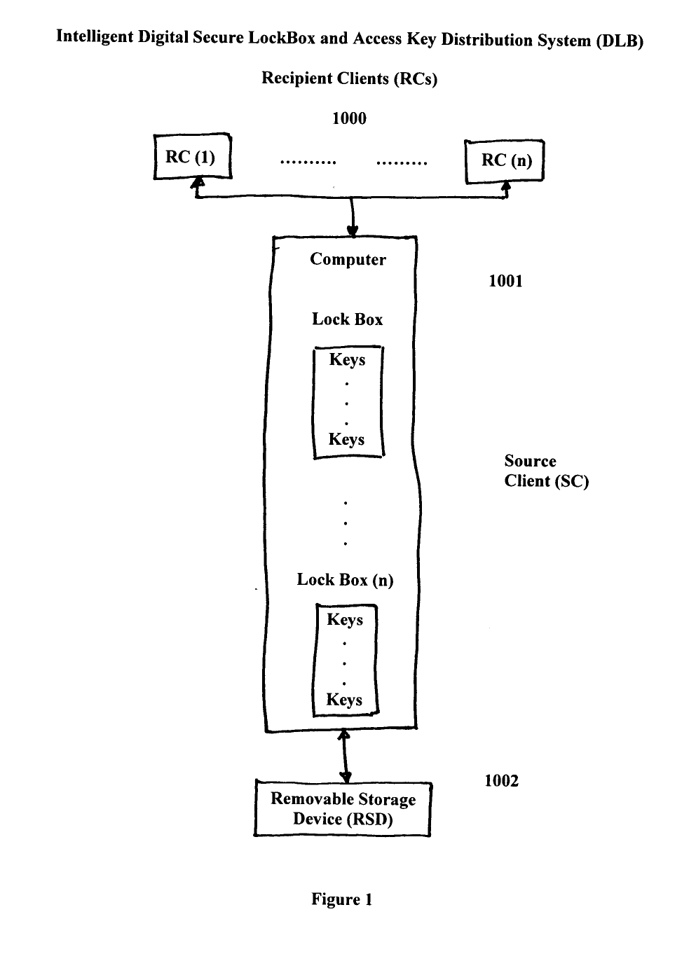

Shown in FIG. 1 is the SC's computer or digital device 1001 which includes one or more Lock Boxes containing one of more encryption keys, access codes, passwords PIN numbers or other types of access codes. Also shown is the one or more Recipient Clients (RCs) 1000 and their relationship with the SC's computer 1001 to facilitate the transfer of LockBoxes. The optional component, the removable storage device (RSD) 1002 is also shown. By placing the LockBoxes and related operational controls on to a RSD the user is free to use any computer with media device access to operate a LockBox.

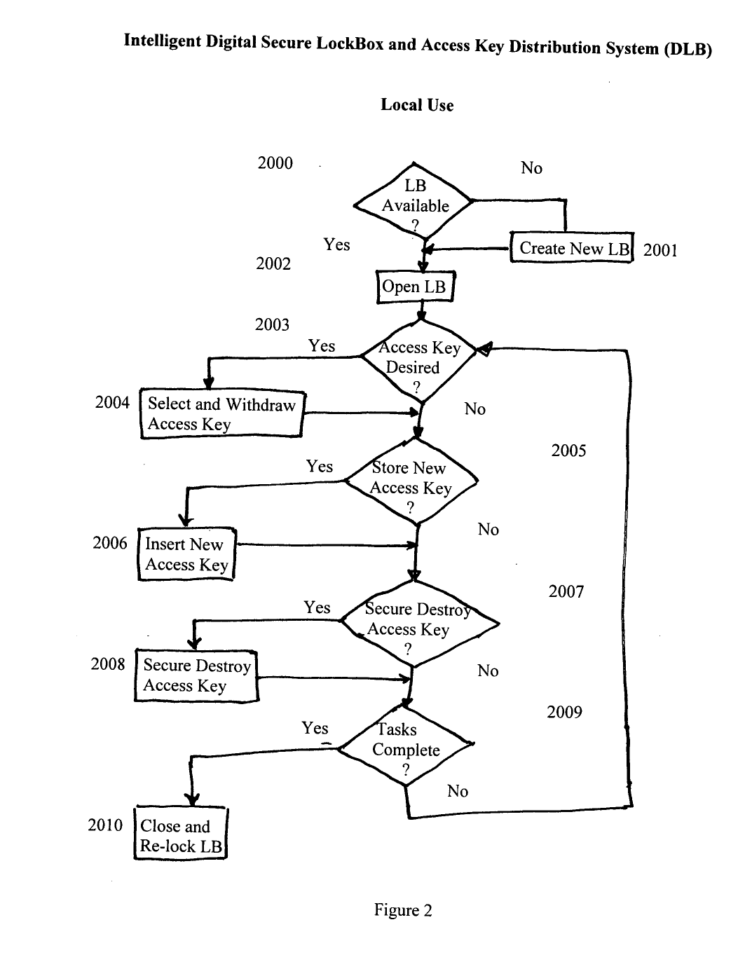

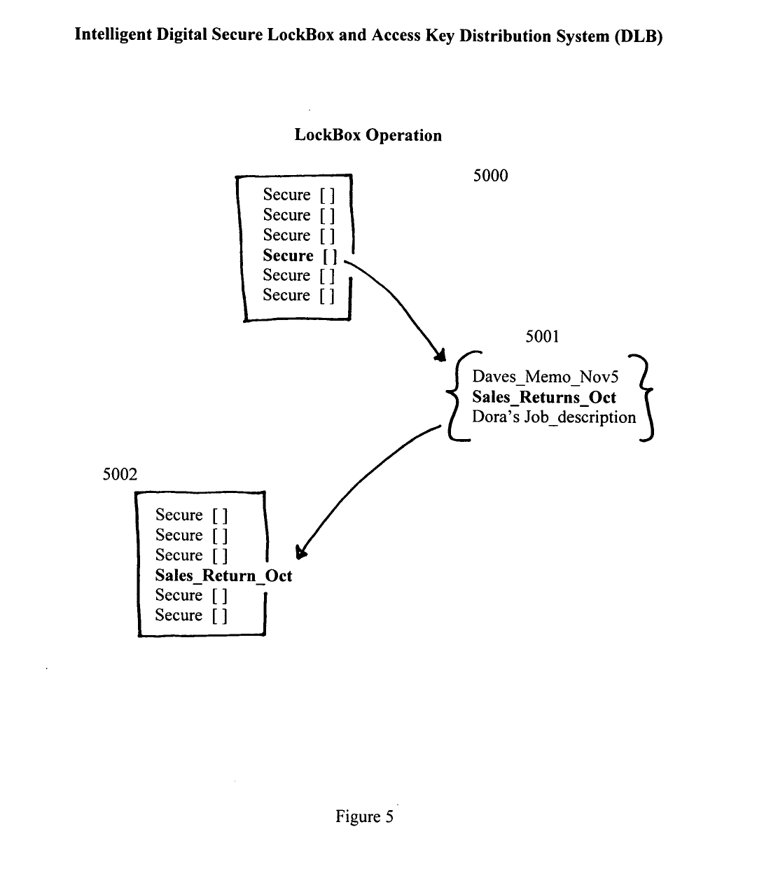

FIG. 2 illustrates an example of the steps associated with the establishment and maintenance of a LockBox by a source client. The steps are self evident by the point and click features which are represented by any user friendly user interface implementation of the invention, some of which is defined in FIG. 5.

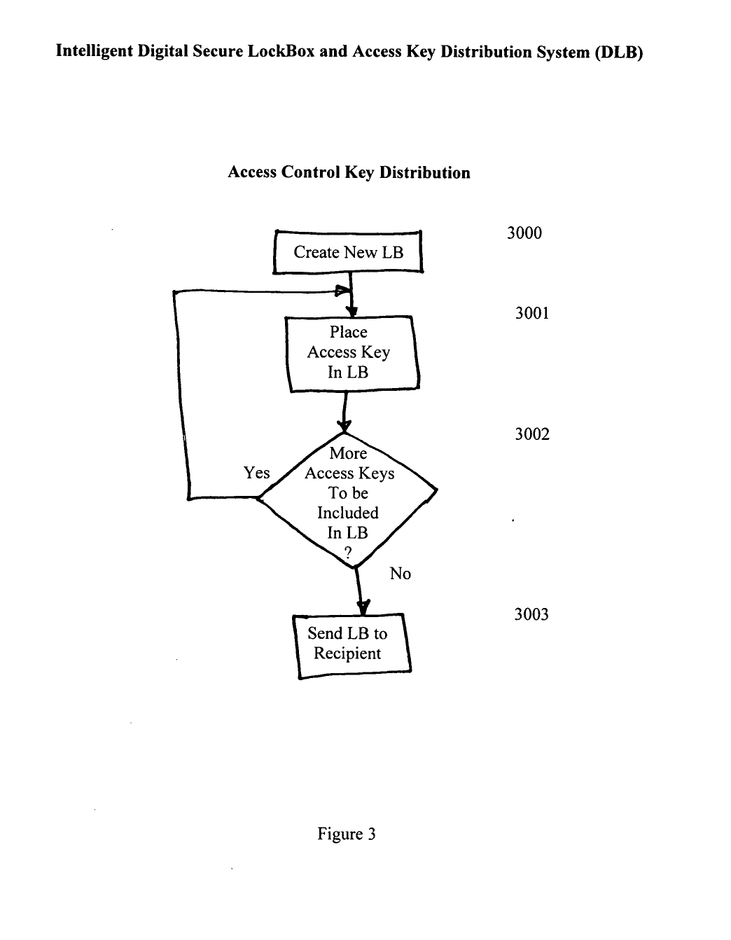

FIG. 3 illustrates an example of the steps associated with the establishment and preparation of a unique LockBox that is being prepared for the purpose of delivering one or more encryption keys, access codes, passwords or other access code to a third party. To facilitate this delivery, the third party must have been previously been provided the access code to the LockBox which is about to be forwarded to the third party. The steps are self evident by the point and click features which are represented by any user friendly user interface implementation of the invention, some of which is defined in FIG. 5.

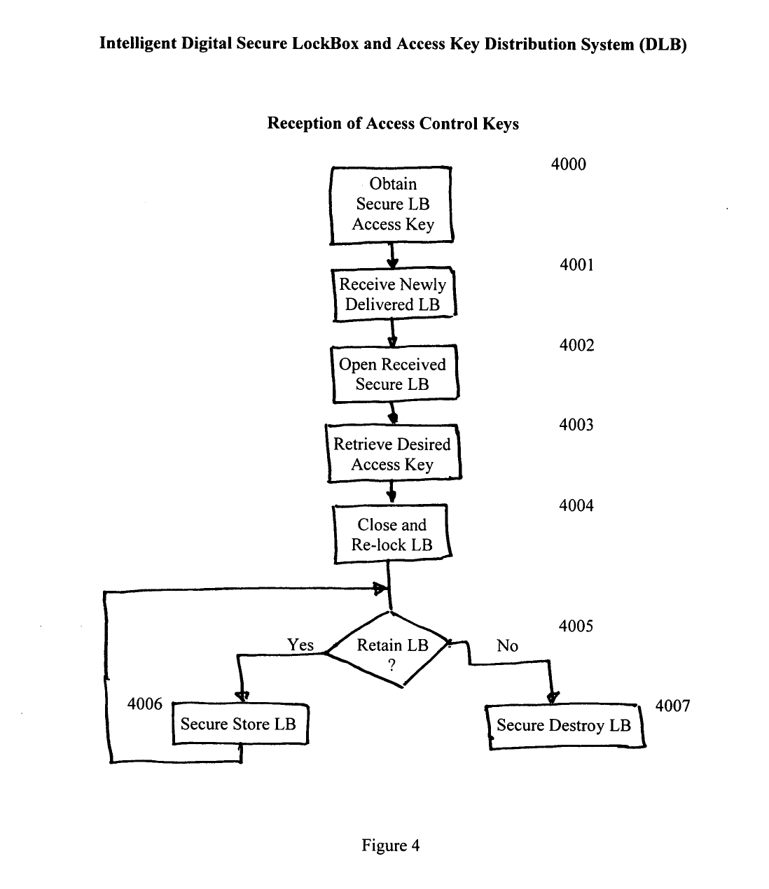

FIG. 4 illustrates an example of the steps associated with the reception and utilization of a unique LockBox that has been delivered to a third party recipient client for the purpose of delivering one or more encryption keys, access codes, passwords or other access code to the third party. To facilitate this delivery, the third party must have been previously been provided the access code to the LockBox which being delivered. The steps are self evident by the point and click features which are represented by any user friendly user interface implementation of the invention, some of which is defined in FIG. 5.

FIG. 5 illustrates an example of the steps associated with the viewing and the selection of the specific access code from a LockBox for application to a process or procedure. Each one of the titled line which states “secure” is the storage location of one or more access codes. By clicking on one or more of the “secure” titles the line will display the titles of the access codes which are contained with in the “secure” vault. By clicking upon one of the displayed titles the access code associated with that specific title is made available for utilization to unlock an encryption wrapped data file or to display a password, or to let the user drag and drop the access code on the access code requesting window of a Web page, etc. Conversely as long as the vault behind a “secure” listed line is not full the user may insert one or more new access codes into the vault. When not in use the LockBox is encryption wrapped. The user must maintain secure control of the access code to the LockBox. That is a necessary fact; however, it is much easier to remember and to securely control one access code rather than 100s. All of the 100s can be placed into a LockBox and therefore only one need be secured.

1. An intelligent digital secure lock box and access key distribution system (DLB), comprising:
a) A source computer or digital device which includes within the device one or more digital lock boxes which can be secured with encryption and within the lock boxes are one of more digital access codes or keys;
b) One or more recipient clients at receiving computers or digital devices which can receive one of more digital lock boxes and with a provided encryption access key to the delivered lock boxes such that the recipient client can obtain access to the contents of a delivered secure digital lock boxes;
c) One or more removable storage devices (RSD) or digital media storage devices, such as a Flash USB drive, a CD, a DVD, a computer diskette or other media device, can be used to provide optional programmability, portability and off-line storage, and back-up storage capabilities to one or more lock boxes; and
d) Where the digital lock box can be encrypted and stored on a the computer hard drive, a removable digital storage media or delivered digitally to a designated distribution computer and a ultimate recipient client.
e) Where the digital lock box can become a personal item which the individual carries with him or her with all of his or her secure access codes and passwords allowing the individual the power and the capability to quickly and easily setup his access to e-mail accounts, secure areas on web pages open on-line banking and other password or access key activities from any computer anywhere in the worlds.

2. Wherein the contents of the digital lock box defined in claim 1 includes digital access codes and textual or digital imagery associated therewith.

3. Wherein the digital access codes defined in claim 1 can be manually and electronically generated: encryption access keys, pin numbers, pass words, account numbers, ID numbers, and associated types of access codes and sensitive, confidential or trade secret codes or ID data.

4. Wherein the delivery of the encryption access key to a delivered lock box defined in claim 1 can be by various means of delivery and the delivered encryption access key may open more than just a single digital lock box.

5. Wherein the user of the lock box defined in claim 1 has the capabilities to input, edit, copy, and delete the digital access codes stored in the digital lock box and to input, edit, copy, and delete the textual or digital imagery associated therewith.

6. Wherein the user of the lock box defined in claim 1 has the capabilities to use the device in a stand alone, single computer or digital device configuration or as part of a configuration that includes a network of computers and digital devices.

7. Wherein the user of the lock box defined in claim 1 has the capabilities to use the device in a direct user present at the computer or digital device configuration or as part of remote access configuration which may include wireline, wireless or other modes of communications.
